(19) United States
(12) Patent Application Publication
(10) Pub. No.: US 2015/0249303 A1
(43) Pub. Date: Sep. 3, 2015

(54) CONNECTOR

(71) Applicants: HONG FU JIN PRECISION INDUSTRY (WuHan) Co., LTD., Wuhan (CN); HON HAI PRECISION INDUSTRY CO., LTD., New Taipei (TW)

(72) Inventors: SHENG YIN, Wuhan (CN); WEI LIANG, Wuhan (CN); LI-PING FAN, Wuhan (CN); YU-LIN LIU, Wuhan (CN)

(21) Appl. No.: 14/540,244

(22) Filed: Nov. 13, 2014

(30) Foreign Application Priority Data
Feb. 28, 2014 (CN) 201410068801.1

(51) Int. Cl. H01R 13/627; H01R 24/00

(52) U.S. Cl. CPC H01R 13/6272; H01R 24/00; H01R 2105/00

(57) ABSTRACT

An electrical connector includes a plug and a socket coupled to the plug. The plug includes a base body and at least one first pin and a second pin. The at least one first pin and the second pin are attached to the base body. The socket defines at least one first hole and a second hole. A size of the first hole corresponds to the first pin and is configured to receive the first pin. A size of the second hole corresponds to that of the second pin and is configured to receive the second pin. A size of the second pin is greater than that of the first hole to prevent any wrong connections.

### CROSS-REFERENCE TO RELATED APPLICATIONS

This application claims priority to Chinese Patent Application No. 201410068801.1 filed on Feb. 28. 2014, the contents of which are incorporated by reference herein.

### FIELD

The present disclosure relates to electrical connections.

### BACKGROUND

Connectors include plugs and sockets. The plug includes a number of pins. The socket defines a number of holes for receiving the pins. The size and shape of the each pin are the same. Thus, the pin can go into a wrong hole.

### BRIEF DESCRIPTION OF THE DRAWINGS

Implementations of the present technology will now be described, by way of example only, with reference to the attached figures.

FIG. 1 is an exploded, isometric view of a connector including a plug according to an exemplary embodiment.

FIG. 2 is an enlarged, isometric view of the plug of the connector of FIG. 1.

FIG. 3 is an isometric view of the connector of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasable connected. The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series, and the like.

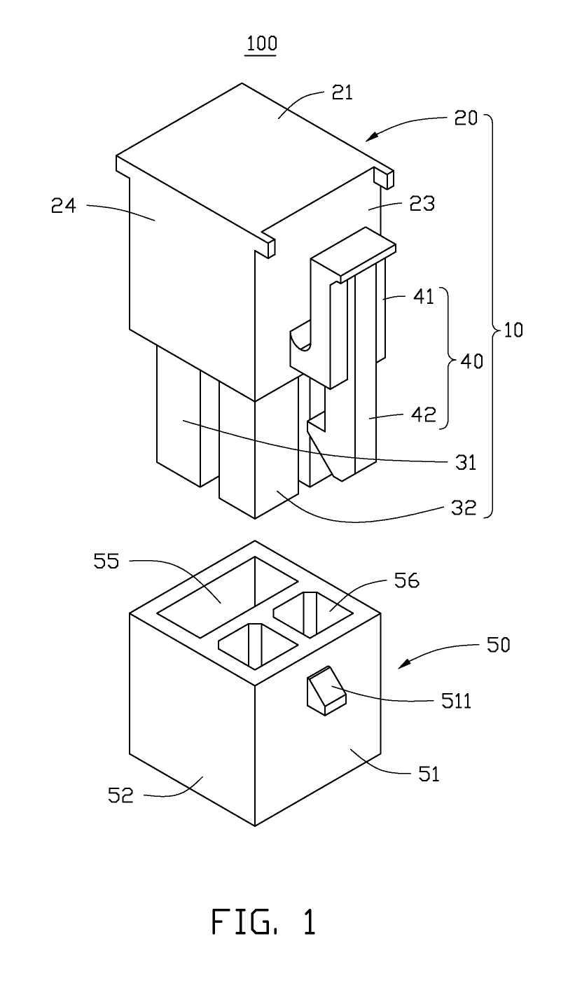

FIG. 1 illustrates a connector 100 including a plug 10 and a socket 50. The plug 10 includes a base body 20, two first pins 32, a second pin 31, and a buckle 40. The socket 50 defines two first holes 56 and a second hole 55. The second hole 55 is configured to accept the second pin 31. The first hole 56 is configured to accept the first pin 32. Thus, the plug 10 can be coupled to the socket 50.

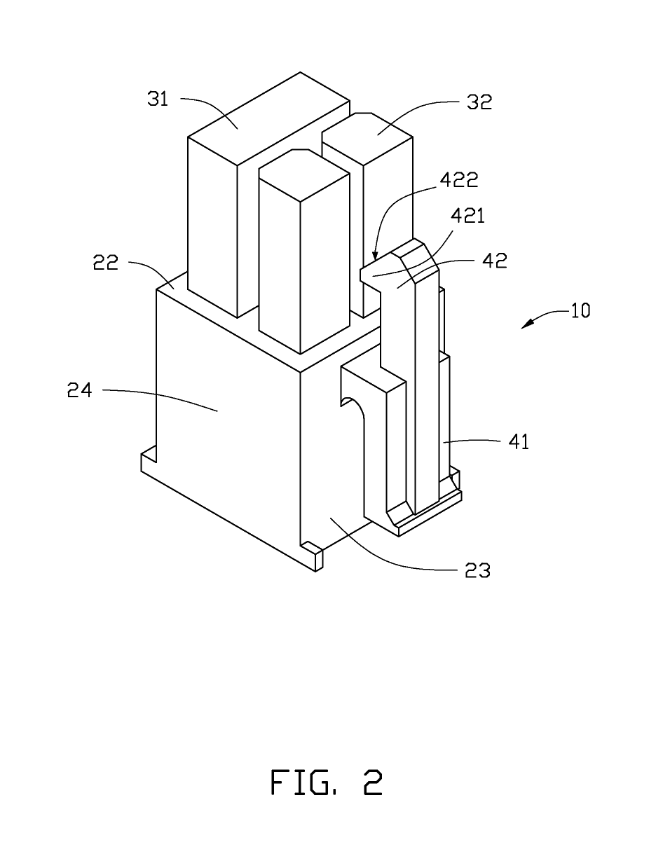

Further referring to FIG. 2, the base body 20 includes a top surface 21, a bottom surface 22, two first sidewalls 23, and two second sidewalls 24. The top surface 21 is parallel to the bottom surface 22. The first sidewalls 23 and the second sidewalls 24 are attached between the top surface 21 and the bottom surface 22. The first sidewalls 23 are parallel to each other. The second sidewalls 24 are parallel to each other and are attached between the two first sidewalls 23. The second pin 31 and the two first pins 32 are perpendicularly attached to the bottom surface 22. The size and the shape of the second pin 31 correspond to the size and the shape of the second hole 55. The size and the shape of the first pin 32 correspond to the size and the shape of the first hole 56. The area of the cross section of the second pin 31 is different from the area of the cross section of the first pin 32. The second pin 31 cannot be accepted in any first hole 56. Only when the second pin 31 and the first pins 32 are respectively aligned with the second hole 55 and the first holes 56 can the plug 10 be coupled to the socket 50.

In one embodiment, the area of the cross section of the second pin 31 is greater than the area of the cross section of the first pin 32. The height of the second pin 31 is same as the height of the first pin 32. The shape of the second pin 31 and the first pins 32 are substantially cubic. The second pin 31 and the first pins 32 are parallel to the first sidewall 23. The two first pins 32 are positioned at same side of the second pin 31 and parallel to the first sidewall 23. The two first pins 32 are symmetrically positioned in relation to the axis of the second pin 31 perpendicular to the first sidewall 23.

The buckle 40 includes a fixing member 41 and a clip 42. The fixing member 41 is attached to the first sidewall 23 away from the second pin 31. The clip 42 extends from the fixing member 41 to the first pin 32. The clip 42 includes a hook portion 421 extending toward the first pin 32. The clip 42 is elastic. The hook portion 421 includes a slant surface 422 at an end of the clip 42 away from the fixing member 41.

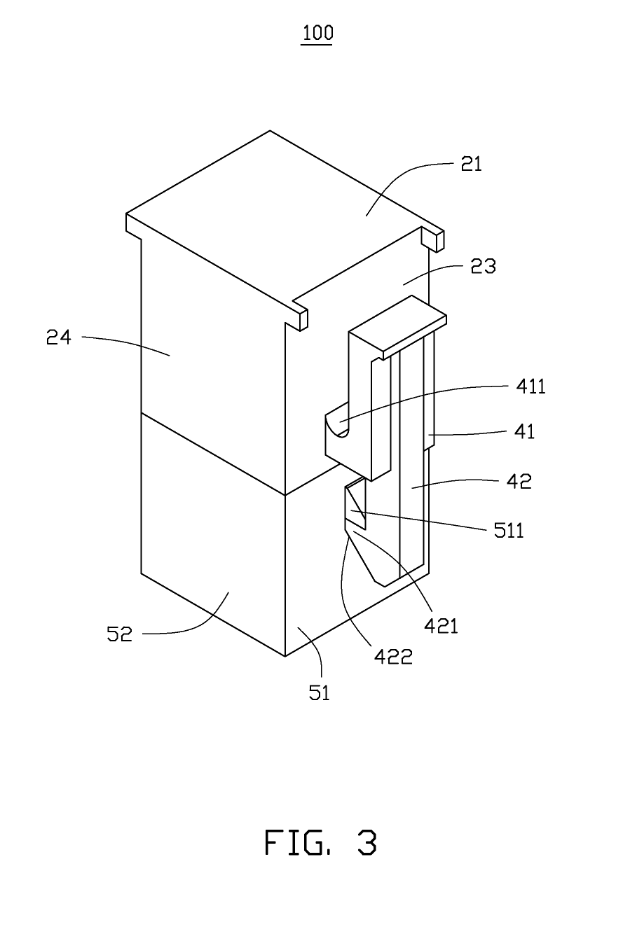

The socket 50 includes two third sidewalls 51 and two fourth sidewalls 52. The two third sidewalls 51 are parallel to each other. The two fourth sidewalls 52 are attached between the two third sidewalls 51 and are parallel to each other. The two first holes 56 are positioned at same side of the second hole 55 and parallel to the third sidewall 51. The two first holes 56 are symmetrically positioned in relation to the central axis of the second hole 55 perpendicular to the third sidewall 51. The socket 50 further includes a wedge block 511. The wedge block 511 is attached to one of the third sidewalls 51 adjacent to the first hole 56. Further referring to FIG. 3, when the plug 10 is coupled to the socket 50, the wedge block 511 abuts against the slant surface 422 and deforms the clip 42 to engage with the hook portion 421. Thereby, the plug 10 is firmly attached to the socket 50. The width of the third sidewall 51 is same as the width of the first sidewall 23. The width of the fourth sidewall 52 is same as the width of the second sidewall 24. When the plug 10 is coupled to the socket 50, the first sidewall 23 and the third sidewall 51 form a single planar surface and the second sidewall 23 and the third sidewall 52 form a single planar surface.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A plug coupled to a socket comprising:
a base body comprising a bottom surface;
at least one first pin attached to the bottom surface, the at least one first pin configured to be received in at least one first hole defining on the socket; and
a second pin attached to the bottom surface, the second pin configured to be received in a second hole defined on the socket, a size of the second pin being different from that of the first pin and can not being received in any the first hole.

2. The plug as claimed in claim 1, wherein the plug comprises two first pins, the two first pins are positioned at the same side of the second pin.

3. The plug as claimed in claim 2, wherein the two first pins are symmetrically positioned in relation to the central axis of the second pin.

4. The plug as claimed in claim 1, wherein the height of the second pin is the same as the height of the first pin.

5. The plug as claimed in claim 1, wherein the base body further comprises a top surface, two first sidewalls and two second sidewalls, the first sidewalls and the second sidewalls are attached between the top surface and the bottom surface.

6. The plug as claimed in claim 5, wherein the first sidewalls are parallel to each other, the second sidewalls are parallel to each other and are attached between the two first sidewalls.

7. The plug as claimed in claim 5, wherein the plug further comprises a buckle, the buckle is configured to engage with the socket when the plug is coupled to the socket.

8. The plug as claimed in claim 7, wherein the buckle comprises a fixing member and a clip, the fixing member is attached to the first sidewall, the clip extends from the fixing member to the first pin to engage with the socket.

9. The plug as claimed in claim 8, wherein the clip comprises a hook portion toward the first pin, the hook portion is configured to engage with a wedge block of the socket.

10. The plug as claimed in claim 9, wherein the clip is elastic, the hook portion comprises a slant surface at an end of the clip away from the fixing member, the slant surface abuts against the wedge block to deform the clip to engage with the wedge block.

11. A plug coupled to a socket comprising:
a base body;
at least one first pin attached to the base body, the at least one first pin configured to be received in at least one first hole defining on the socket; and
a second pin attached to the base body, the second pin configured to be received in a second hole defined on the socket, a size of the second pin being greater than that of the first pin and can not being received in any the first hole.

12. The plug as claimed in claim 11, wherein the plug comprises two first pins, the two first pins are positioned at the same side of the second pin.

13. The plug as claimed in claim 12, wherein the two first pins are symmetrically positioned in relation to the central axis of the second pin.

14. The plug as claimed in claim 11, wherein the base body further comprising a top surface, two first sidewalls and two second sidewalls, the first sidewalls and the second sidewalls are attached between the top surface and the bottom surface, the first sidewalls are parallel to each other, the second sidewalls are parallel to each other and are attached between the two first sidewalls.

15. The plug as claimed in claim 14, wherein the plug further comprises a buckle, the buckle is configured to engage with the socket when the plug is coupled to the socket.

16. The plug as claimed in claim 15, wherein the buckle comprises a fixing member and a clip, the fixing member is attached to the first sidewall, the clip extends from the fixing member to the first pin to engage with the socket.

17. A socket coupled to a plug comprising:
at least one first hole configured to receive at least one first pin of the plug, a size of the first hole corresponding to that of the first pin; and
a second hole configured to receive a second pin of the plug, a size of the second hole corresponding to that of the second pin and being greater than that of the first hole so that only when the first pin is received in the first hole and the second pin is received in the second hole, the socket can be coupled to the plug.

18. The socket as claimed in claim 17, wherein the socket comprises two first holes, the two first holes are positioned the same side of the second hole.

19. The socket as claimed in claim 18, wherein the two first holes are symmetrically positioned two sides of a symmetry axis of the second hole.

20. The socket as claimed in claim 17, wherein the socket further comprises a wedge block, the wedge block is configured to engage with the plug when the socket is coupled to the plug.
